(19) United States
(12) Patent Application Publication
(10) Pub. No.: US 2007/0008738 A1
(43) Pub. Date: Jan. 11, 2007

(54) Two-Directions Light Transmission Reflective-Transmissive Prism Sheet, Two-Directions Backlight Assembly, and Liquid Crystal Display Having the Two-Directions Backlight Assembly

(75) Inventors: Byung-woong Han, Incheon Metropolitan City (KR); Young-bee Chu, Gyeonggi-do (KR); Kyu-seok Kim, Gyeonggi-do (KR); Dong-cheol Kim, Gyeonggi-do (KR)

Correspondence Address: PATENT LAW GROUP LLP, 2635 NORTH FIRST STREET, SUITE 223, SAN JOSE, CA, 95134, US

(73) Assignee: SAMSUNG ELECTRONICS CO., LTD., Gyeonggi-do (KR)

(21) Appl. No.: 11/425,274

(22) Filed: Jun. 20, 2006

(30) Foreign Application Priority Data
Jul. 11, 2005 (KR) 10-2005-0062403

(51) Int. Cl. F21V 5/02

(52) U.S. Cl. 362/607; 362/611; 362/339

(57) ABSTRACT

A two-directions light transmission transflective prism sheet, a two-directions backlight assembly, and a two-directions liquid crystal display (LCD) device having the two-directions backlight assembly are provided. The two-directions light transmission transflective prism sheet includes a two-directions light transmission transflective film that reflects some incident light irradiated from a light source and transmits the remainder of the light, and a plurality of prism patterns that are formed on one surface of the two-directions light transmission transflective film to have a predetermined height and a predetermined width.

### REFERENCE TO RELATD APPLICATON

This application claims priority from Korean Patent Application No. 10-2005-0062403 filed on Jul. 11, 2005 in the Korean Intellectual Property Office, the disclosure of which is incorporated herein by reference in its entirety.

### BACKGROUND OF THE INVENTION

1. Field of the Invention

The present invention relates to a two-directions light transmission reflective-transmissive (transflective) prism sheet, a two-directions backlight assembly, and a liquid crystal display having the two-directions backlight assembly.

2. Description of the Related Art

In general, a liquid crystal display (LCD) is one kind of flat-panel display devices that display images using liquid crystals. LCDs have some notable advantages over other flat-panel display devices. For instance, LCDs are thinner and lighter, consume less power, and are driven at lower driving voltages than other display devices.

Thus, LCDs have been widely used in various applications, including communication devices, such as mobile phones, portable computers, desktop computers, and so on. LCDs are usually one-way display devices that display images in one direction only.

Two-directions LCDs displaying identical or different images in two directions have recently been developed.

A conventional two-directions LCD includes a main LCD panel for displaying a main image, a sub LCD panel for displaying a sub image and a backlight assembly for supplying light to main LCD panel and the sub LCD panel. To realize slimness of the backlight assembly, a single light guide plate is applied. In addition, the backlight assembly includes an optical sheet for distributing light to the main LCD panel and to the sub LCD panel with a predetermined ratio of light, and two prism sheets collecting incident light irradiated from the optical sheet and transmitting the collected light to the main LCD panel and the sub LCD panel.

However, since the conventional two-directions LCD uses two prism sheets, a backlight unit of the conventional two-directions LCD may become bulky, and the manufacturing cost of the conventional two-directions LCD may increase.

### SUMMARY OF THE INVENTION

The present invention provides a two-directions light transmission transflective prism sheet, and a two-directions liquid crystal display (LCD) device having the two-directions backlight assembly.

The present invention also provides a two-directions backlight assembly.

The present invention also provides a two-directions liquid crystal display (LCD) device having the two-directions backlight assembly.

The above stated objects as well as other objects, features and advantages, of the present invention will become clear to those skilled in the art upon review of the following description.

According to an aspect of the present invention, there is provided a two-directions light transmission transflective prism sheet including a two-directions light transmission transflective film that reflects some incident light irradiated from a light source and transmits the remainder of the light, and a plurality of prism patterns formed on one surface of the two-directions light transmission transflective film, the plurality of prism patterns having a predetermined height and a predetermined width.

According to another aspect of the present invention, there is provided a two-directions backlight assembly including a light source generating light, a waveguide plate including a first light exit surface through which light incident upon the waveguide plate is emitted in a first direction and a second light exit surface through which the light incident upon the waveguide plate is emitted in a second direction, the second direction being opposite to the first direction, and a two-directions light transmission transflective prism sheet arranged at one side of the waveguide plate and comprising a two-directions light transmission transflective film that reflects some incident light irradiated from a light source and transmits the remainder of the light, and a plurality of prism patterns formed on one surface of the two-directions light transmission transflective film, the plurality of prism patterns having a predetermined height and a predetermined width.

According to still another aspect of the present invention, there is provided a two-directions liquid crystal display (LCD) device including a two-directions backlight assembly, a first LCD panel, and a second LCD panel. The two-directions backlight assembly includes a light source generating light, a waveguide plate including a first light exit surface through which light incident upon the waveguide plate is emitted in a first direction and a second light exit surface through which the light incident upon the waveguide plate is emitted in a second direction, the second direction being opposite to the first direction, and a two-directions light transmission transflective prism sheet arranged at one side of the waveguide plate and comprising a two-directions light transmission transflective film that reflects some incident light irradiated from a light source and transmits the remainder of the light, and a plurality of prism patterns formed on one surface of the two-directions light transmission transflective film, the plurality of prism patterns having a predetermined height and a predetermined width. The first LCD panel is disposed at one side of the two-directions backlight assembly toward the first direction displays a first image. The second LCD panel is disposed at the other side of the two-directions backlight assembly toward the second direction and displays a second image.

### BRIEF DESCRIPTION OF THE DRAWINGS

The above and other features and advantages of the present invention will become more apparent by describing in detail preferred embodiments thereof with reference to the attached drawings in which:

FIG. 1 is an exploded perspective view of a two-directions light transmission transflective prism sheet according to an exemplary embodiment of the present invention;

FIG. 2 is a cross-sectional view of the two-directions light transmission transflective prism sheet of FIG. 1;

FIG. 3 is a cross-sectional view of a two-directions light transmission transflective prism sheet according to another exemplary embodiment of the present invention;

FIG. 4 is a cross-sectional view of a two-directions light transmission transflective prism sheet according to another exemplary embodiment of the present invention;

FIG. 5 is a cross-sectional view of a two-directions light transmission transflective prism sheet according to another exemplary embodiment of the present invention;

FIG. 6 is an exploded perspective view of a two-directions backlight assembly;

FIG. 7 is a cross-sectional view of the two-directions backlight assembly of FIG. 6; and

FIG. 8 is an exploded perspective view of a two-directions liquid crystal display (LCD) device according to an exemplary embodiment of the present invention.

### DETAILED DESCRIPTION OF THE INVENTION

The present invention will now be described more fully with reference to the accompanying drawings, in which preferred embodiments of this invention are shown. Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

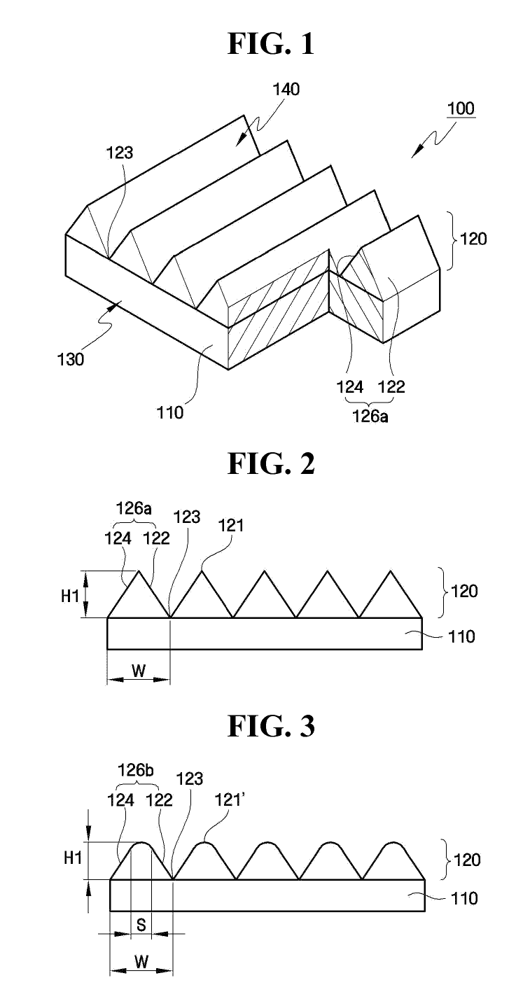

FIG. 1 is an exploded perspective view of a two-directions light transmission transflective prism sheet according to an exemplary embodiment of the present invention, and FIG. 2 is a cross-sectional view of FIG. 1.

Referring to FIGS. 1 and 2, a two-directions light transmission transflective prism sheet 100 includes a two-directions light transmission transflective (reflective-transmissive) film 110 and a plurality of prism patterns 120. Two-directions light transmission transflective prism sheet 100 operates to emit light from a light source in two directions where the two directions are typically opposite to each other.

The two-directions light transmission transflective film 110 reflects some incident light irradiated from a light source via a light incidence surface 130 and transmits the remainder of the light. The two-directions light transmission transflective film 110 may be formed of a transparent, refractive material in a flat panel type. Examples of the two-directions light transmission transflective film 110 include polycarbonate, polyester, and polyethylene terephthalate. The two-directions light transmission transflective film 110 may be formed to a thickness in a range of 50-100 μm. The transmissibility and reflectance of the two-directions light transmission transflective film 110 may be adjusted by adjusting the thickness of the two-directions light transmission transflective film 110.

Although not shown, the two-directions light transmission transflective film 110 may include dispersion particles in order to disperse light. The dispersion particles may be formed of one of titanium dioxide (TiO₂) and silicon dioxide (SiO₂) to a thickness of 10 μm or less. The transmissibility and reflectance of the two-directions light transmission transflective film 110 may be adjusted by changing the material and concentration of the dispersion particles.

The density of the dispersion particles in the two-directions light transmission transflective film 110 may be controlled so that the two-directions light transmission transflective film 110 has a haze characteristic of at least 30%.

The prism patterns 120 are formed on one surface of the two-directions light transmission transflective film 110. Each of the prism patterns 120 is comprised of a light collection portion 126a having a predetermined height H1 and a predetermined width W. The light collection portion 126a collects incident light through the two-directions light transmission transflective film 110 and emits the collected light through a light exit surface 140. The light collection portion 126a comprises a first slope 122 and a second slope 124. In other words, the prism patterns 120 are formed by alternately forming the first slope 122 and the second slope 124 on the two-directions light transmission transflective film 110. A first slope-and-second slope pair may form either a peak 121 or a valley 123. The angle of the peaks 121 of the respective prism patterns 120 may be in a range of 45-135°, and preferably, in a range of 75-80°.

The height H1 may be in a range of 12-25 μm. The width W may be in a range of 1-300 μm. The angle between the sides of the valleys 123 between the respective pairs of prism patterns 120 may be in a range of 70-110°.

The prism patterns 120 may be formed of either acrylic resin or silicon resin. The prism patterns 120 may be formed to have a refractive index of 1.40-1.70, and preferably, a refractive index of 1.50-1.60.

FIG. 3 is a cross-sectional view of a two-directions light transmission transflective prism sheet 100 according to another embodiment of the present invention.

Referring to FIG. 3, the two-directions light transmission transflective prism sheet 100 includes a two-directions light transmission transflective film 110 and a plurality of prism patterns 120. The two-directions light transmission transflective film 110 has already been described above with reference to FIGS. 1 and 2, and thus, its detailed description will not be presented here again.

The prism patterns 120 are formed on one surface of the two-directions light transmission transflective film 110. Each of the prism patterns 120 is comprised of a light collection portion 126b having a predetermined height Hi and a predetermined width W. The light collection portion 126b collects incident light through the two-directions light transmission transflective film 110 and emits the collected light through a light exit surface 140. The light collection portion 126b comprises a first slope 122 and a second slope 124. In other words, the prism patterns 120 are formed by alternately forming the first slope 122 and the second slope 124 on the two-directions light transmission transflective film 110. A first slope-and-second slope pair may form either a peak 121′ or a valley 123. The angle of the peaks 121′ of the respective prism patterns 120 may be in a range of 45-135°, and preferably, the range of 75-80°. A light collection portion 126b constituting each of the prism patterns 120 is formed to have a curved profile with a peak 121′. The length S of a curved portion of the peak 121′ may account for 10-20% of the width W of the light collection portion 126b.

In the present embodiment, the peak 121′ of the light collection portion 126b is formed with a curved profile as illustrated in FIG. 3. Thus, the prism patterns 120 of the two-directions light transmission transflective prism sheet 100 become less likely to suffer cuts and abrasions when sheet 100 comes in contact with another prism sheet or a rear surface of another substrate. In addition, it is possible to prevent the Moire phenomenon from occurring on the screen of an LCD panel, thereby enhancing the display quality of the LCD panel.

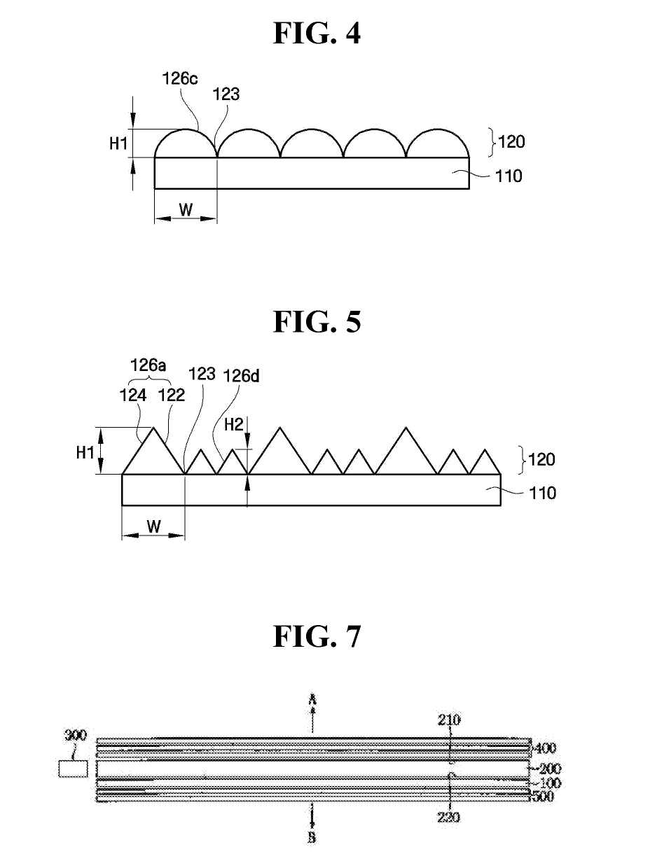

FIG. 4 is a cross-sectional view of a two-directions light transmission transflective prism sheet 100 according to another embodiment of the present invention.

Referring to FIG. 4, the two-directions light transmission transflective prism sheet 100 includes a two-directions light transmission transflective film 110 and a plurality of prism patterns 120. The two-directions light transmission transflective film 110 has already been described above with reference to FIGS. 1 and 2, and thus, its detailed description will not be presented here again.

Each of the prism patterns 120 is comprised of a light collection portion 126c having a predetermined height H1 and a predetermined width W. The light collection portion 126c collects incident light through the two-directions light transmission transflective film 110 and emits the collected light through a light exit surface 140. The light collection portion 126c may be formed to have a cylindrical profile. The prism patterns 120 may be formed of a homogenous isotropic material. For example, the prism patterns 120 may be formed of acryl having a refractive index of 1.493 or a polycarbonate having a refractive index of 1.586. Alternatively, the prism patterns 120 may be formed of polypropylene, polyurethane, polystyrene, or polyvinylchloride.

In the present embodiment, the light collection portion 126c is formed to have a cylindrical profile as illustrated in FIG. 4. Thus, it is possible to achieve a uniform distribution of brightness over the two-directions light transmission transflective prism sheet 100 and eventually enhance the brightness of the two-directions light transmission transflective prism sheet 100.

FIG. 5 is a cross-sectional view of a two-directions light transmission transflective prism sheet 100 according to another embodiment of the present invention.

Referring to FIG. 5, the two-directions light transmission transflective prism sheet 100 includes a two-directions light transmission transflective film 110 and a plurality of prism patterns 120. The two-directions light transmission transflective film 110 has already been described above with reference to FIGS. 1 and 2, and thus, its detailed description will not be presented here again.

Each of the prism patterns 120 is comprised of a first light collection portion 126a having a predetermined width W and a predetermined height H1 and a pair of second light collection portions 126d each pattern having half of the predetermined width W and a predetermined height H2. The prism patterns 120 are formed by alternately forming the first light collection portion 126a and the pair of second light collection portions 126d on the two-directions light transmission transflective film 110. The height H1 may be greater than the height H2 in a range of 1-2 μm. For example, if the height H1 is 26 μm, the height H2 may be in a range of 24-25 μm. Thus, by using the first light collection portion 126a and the pair of second light collection portions 126d having different heights, the heights of the prism patterns 120 vary at a predetermined interval.

In the present embodiment, the prism patterns 120 are formed by alternately forming the first light collection portion 126a and the pair of second light collection portion 126d on the two-directions light transmission transflective film 110. Therefore, it is possible to reduce the contact area between the prism patterns 120 and another prism sheet or a rear surface of another substrate and to prevent light coupling from occurring in a region on the two-directions light transmission transflective film 110 where the pair of second light collection portions 126d are formed.

In the present embodiment, the first light collection portion 126a or the pair of second light collection portions 126d may be formed to have a curved profile at the peak, as shown in FIG. 3. Alternatively, the first light collection portion 126a or the pair of second light collection portions 126D may be formed to have a cylindrical profile, s shown in FIG. 4. In short, the shape of the prism patterns 120 may be varied within the scope of the present invention.

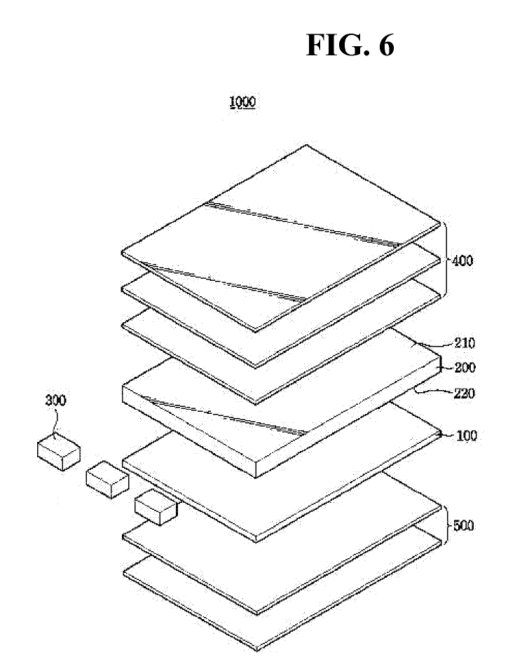

FIGS. 6 and 7 are an exploded perspective view and a cross-sectional view, respectively, of a two-directions backlight assembly 1000 according to an exemplary embodiment of the present invention.

Referring to FIGS. 6 and 7, the two-directions backlight assembly 1000 includes a light source 300 generating light, a waveguide plate 200 guiding the path of light, and a two-directions light transmission transflective prism sheet 100 controlling the amount of light emitted in two directions from the waveguide plate 200.

The light source 300 is located on one side of the waveguide plate 200 and generates light when driven by a driving voltage applied from outside the two-directions backlight assembly 1000. The light source 300 may comprise at least one light-emitting diode (LED). Alternatively, the light source 300 may be comprised of a cold cathode fluorescence lamp (CCFL) formed in a cylindrical shape.

The waveguide plate 200, which is formed as a hexahedron having a predetermined thickness, guides the path of incident light irradiated from the light source 300 and emits lights in two directions. In order to emit light in two directions, the waveguide plate 200 includes a first light exit surface 210 through which light is emitted in a first direction A and a second light exit surface 220 through which light is emitted in a second direction B. For example, the second direction B may be opposite to the first direction A, and the second light exit surface 220 may be parallel to the first light exit surface 210.

The waveguide plate 200 may also include a plurality of reflection patterns (not shown) formed on the first or second light exit surface 210 or 220 to scatter and reflect light incident upon the first or second light exit surface 210 or 220. In addition, a plurality of prism patterns (not shown) may also be formed on the second light exit surface 220 of the waveguide plate 200.

The two-directions light transmission transflective prism sheet 100 is formed on one surface of the waveguide plate 200. The two-directions light transmission transflective prism sheet 100 includes a two-directions light transmission transflective film 110 that reflects some light emitted through the second light exit surface 220 and transmits the remainder of the light. The two-directions light transmission transflective prism sheet 100 further includes a plurality of prism patterns 120 that collect incident light through the two-directions light transmission transflective film 110 and emit the collected light.

The two-directions backlight assembly 1000 controls the amount of light emitted toward the first direction A and the amount of light emitted toward the second direction B so that the ratio of the amount of light emitted toward the first direction A to the amount of light emitted toward the second direction B is maintained at about 6:4.

In order to achieve this ratio, the two-directions light transmission transflective film 110 must be formed to have a 15-20% transparency. In order to form a two-directions light transmission transflective film 110 with 15-20% transparency, the two-directions light transmission transflective film 110 must be formed to have a thickness in a range of 50-100 μm.

The two-directions backlight assembly 1000 also includes a plurality of first optical sheets 400 and a plurality of second optical sheets 500.

The first optical sheets 400 are formed on the first light exit surface 210 of the waveguide plate 200 and enhance the brightness of light emitted toward the first direction A through the first light exit surface 210. In other words, the first optical sheets 400 may include a diffusion sheet that diffuses light or at least one prism sheet that collects light.

The second optical sheets 500 may include a diffusion sheet or at least one prism sheet in order to enhance the brightness of light emitted toward the second direction B through the second light exit surface 220 of the waveguide plate 200 and then transmitted by the two-directions light transmission transflective prism sheet 100. The two-directions light transmission transflective prism sheet 100 may be formed to diffuse light, in which case, the diffusion sheet included in the second optical sheets 500 is optional.

The second optical sheets 500 may be formed to have almost as large an area as the second light exit surface 220 and the two-directions light transmission transflective prism sheet 100. The area of the second optical sheets 500 may be altered upon a user's request according to, for example, the location of the second optical sheets 500 in the two-directions backlight assembly 1000. The second optical sheets 500 may have the same size as a second LCD panel (not shown) that displays an image using the light transmitted by the second optical sheets 500.

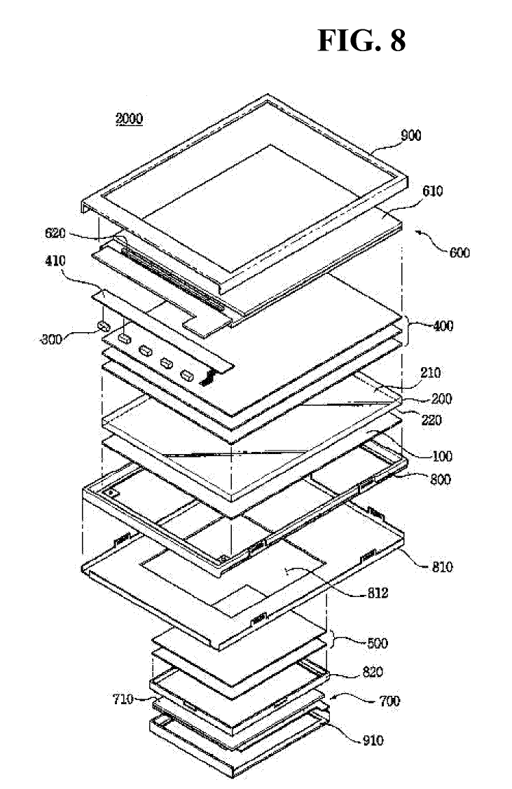

FIG. 8 is an exploded perspective view of a two-directions LCD 2000 according to an exemplary embodiment of the present invention.

Referring to FIG. 8, the two-directions LCD 2000 includes a two-directions backlight assembly constructed in a similar manner to two-directions backlight assembly 1000 of FIG. 6, a first display unit 600, and a second display unit 700.

The two-directions backlight assembly in FIG. 8 includes a light source 300, a waveguide plate 200, a two-directions light transmission transflective prism sheet 100, and first and second optical sheets 400 and 500. The light source 300, the waveguide plate 200, the two-directions light transmission transflective prism sheet 100, and the first and second optical sheets 400 and 500 have the same structures as their respective counterparts illustrated in FIGS. 1 through 6, and thus, their detailed descriptions will be skipped.

The light source 300 may be comprised of a plurality of LEDs fixed in a row onto a flexible printed circuit board (PCB) 410 and generate light when driven by a driving voltage applied through the flexible PCB 410.

The two-directions backlight assembly in FIG. 8 also includes first, second, and third receiving containers 800, 810, and 820.

The first receiving container 800 is formed with a rectangular frame and guides the locations of the light source 300 and the waveguide plate 200.

The second receiving container 810 forms a storage space together with the first receiving container 800 when coupled to the first receiving container 800. The two-directions light transmission transflective prism sheet 100, the light source 300, and the waveguide plate 200 are sequentially mounted in the storage space formed by the first and second receiving container 800 and 810. An opening 812 is formed through the second receiving container 810 to have as large a size as the second optical sheets 500. Light passing through the two-directions light transmission transflective prism sheet 100 is transmitted onto the second optical sheets 500 through the opening 812.

The third receiving container 820 is connected to a location of the rear surface of the second receiving container 810, the location corresponding to the opening 812. The third receiving container 820 fixes the second optical sheets 500.

The first display unit 600 is mounted in the first receiving container 800 and is placed over the first optical sheets 400. The first display unit 600 includes a first LCD panel 610 that displays a first image. The first LCD panel 610 displays the first image using light emitted from the first light exit surface 210 of the waveguide plate 200 and then transmitted by the first optical sheets 400 in the first direction A. The first display unit 600 also includes a first driving chip 620 that drives the first LCD panel 610. The first driving chip 620 may be directly mounted in the first LCD panel 610.

The second display unit 700 is mounted in the third receiving container 820. The second display unit 700 includes a second LCD panel 710 and a second driving chip (not shown). The second LCD panel 710 displays a second image using light emitted from the second light exit surface 220 of the waveguide plate 200 and then transmitted by the second optical sheets 500 in the second direction B. The second image may be identical to the first image or may be different from the first image.

The first LCD panel 610 and the second LCD panel 710 may be formed to have the same size or different sizes from each other upon a user's request. In the present embodiment, the second LCD panel 710 is formed to be smaller than the first LCD panel 610.

The two-directions LCD 200 also includes a first chassis 900 that forms a space together with the first receiving container 800 when coupled to the first receiving container 800 and fixes the first LCD panel 610 inside the space and a second chassis 910 that forms a space together with the third receiving container 820 when coupled to the third receiving container 820 and fixes the second LCD panel 710 inside the space. The first and second chassis 900 and 910 prevent the first and second LCD panels 610 and 710, respectively, from being separated from the first and third receiving containers 800 and 820, respectively, and protect the first and second LCD panels from external impacts.

As described above, according to the present invention, it is possible to efficiently control the ratio of the amount of light emitted toward one direction to the amount of light emitted toward another direction by using a two-directions light transmission transflective prism sheet including a two-directions light transmission transflective film reflecting some incident light irradiated from a light source and transmitting the remainder of the light, and a plurality of prism patterns formed on one surface of the two-directions light transmission transflective film to have a predetermined height and a predetermined width and collecting and emitting incident light irradiated from the two-directions light transmission transflective film. Therefore, it is possible to improve the display quality of a two-directions LCD.

In addition, it is possible to reduce the thickness and manufacturing cost of a two-directions LCD by reducing the number of elements of a two-directions backlight assembly.

While the present invention has been particularly shown and described with reference to exemplary embodiments thereof, it will be understood by those of ordinary skill in the art that various changes in form and details may be made therein without departing from the spirit and scope of the present invention as defined by the following claims. Therefore, it is to be understood that the above-described embodiments have been provided only in a descriptive sense and will not be construed as placing any limitation on the scope of the invention.

What is claimed is:

1. A two-directions light transmission transflective prism sheet comprising:
a two-directions light transmission transflective film that reflects some incident light irradiated from a light source and transmits the remainder of the light; and
a plurality of prism patterns formed on one surface of the two-directions light transmission transflective film, the plurality of prism patterns having a predetermined height and a predetermined width.

2. The two-directions light transmission transflective prism sheet of claim 1, wherein the plurality of prism patterns is formed by alternately forming a first slope and a second slope, each pair of the first slope and the second slope forming a peak or a valley in the plurality of prism patterns.

3. The two-directions light transmission transflective prism sheet of claim 2, wherein the angle of the peaks of the plurality of prism patterns is in a range of 45-135°

4. The two-directions light transmission transflective prism sheet of claim 2, wherein the angle between the first slope and the second slope in the valley of respective pairs of adjacent prism patterns is in a range of 70-110°.

5. The two-directions light transmission transflective prism sheet of claim 2, wherein the prism patterns have a curved profile at their respective peaks.

6. The two-directions light transmission transflective prism sheet of claim 1, wherein the prism patterns have a refractive index of 1.40-1.70.

7. The two-directions light transmission transflective prism sheet of claim 1, wherein the two-directions light transmission transflective film has a haze characteristic of at least 30%.

8. The two-directions light transmission transflective prism sheet of claim 1, wherein the two-directions light transmission transflective film comprises dispersion particles dispersing light.

9. The two-directions light transmission transflective prism sheet of claim 8, wherein the dispersion particles are formed of one of titanium dioxide (TiO₂) and silicon dioxide (SiO₂).

10. The two-directions light transmission transflective prism sheet of claim 1, wherein the two-directions light transmission transflective film is formed of one selected from the group consisting of polycarbonate, polyester, and polyethylene terephthalate.

11. The two-directions light transmission transflective prism sheet of claim 1, wherein the two-directions light transmission transflective film has a thickness in a range of 50-100 μm.

12. The two-directions light transmission transflective prism sheet of claim 1, wherein the prism patterns have a height in a range of 12-25 μm.

13. The two-directions light transmission transflective prism sheet of claim 1, wherein the prism patterns have a width in a range of 1-300 μm.

14. The two-directions light transmission transflective prism sheet of claim 1, wherein the prism patterns have a cylindrical profile with a predetermined height and a predetermined width.

15. The two-directions light transmission transflective prism sheet of claim 1, wherein the heights of the prism patterns vary at a predetermined interval.

16. The two-directions light transmission transflective prism sheet of claim 1, wherein the prism patterns are formed of either acrylic resin or silicon resin.

17. A two-directions backlight assembly comprising:
a light source generating light;
a waveguide plate including a first light exit surface through which light incident upon the waveguide plate is emitted in a first direction and a second light exit surface through which the light incident upon the waveguide plate is emitted in a second direction, the second direction being opposite to the first direction; and
a two-directions light transmission transflective prism sheet arranged at one side of the waveguide plate and comprising a two-directions light transmission transflective film that reflects some incident light irradiated from a light source and transmits the remainder of the light, and a plurality of prism patterns formed on one surface of the two-directions light transmission transflective film, the plurality of prism patterns having a predetermined height and a predetermined width.

18. The two-directions backlight assembly of claim 17, further comprising:
a plurality of first optical sheets arranged on the first light exit surface for enhancing the brightness of light emitted through the first light exit surface in the first direction; and
a plurality of second optical sheets arranged on the second light exit surface for enhancing the brightness of light emitted through the second light exit surface in the second direction.

19. The two-directions backlight assembly of claim 17, wherein the plurality of prism patterns is formed by alternately forming a first slope and a second slope, each pair of the first slope and the second slope forming a peak or a valley in the plurality of prism patterns.

20. The two-directions backlight assembly of claim 19, wherein the angle of the peaks of the plurality of prism patterns is in a range of 45-135°.

21. The two-directions backlight assembly of claim 19, wherein the angle between the first slope and the second slope in the valley of respective pairs of adjacent prism patterns is in a range of 70-110°.

22. The two-directions backlight assembly of claim 17, wherein the prism patterns have a refractive index of 1.40-1.70.

23. The two-directions backlight assembly of claim 17, wherein the two-directions light transmission transflective film has a haze characteristic of at least 30%.

24. The two-directions backlight assembly of claim 17, wherein the two-directions light transmission transflective film comprises dispersion particles dispersing light.

25. The two-directions backlight assembly of claim 24, wherein the dispersion particles are formed of one of titanium dioxide (TiO₂) and silicon dioxide (SiO₂).

26. A two-directions liquid crystal display (LCD) device comprising:
a two-directions backlight assembly including a light source generating light, a waveguide plate including a first light exit surface through which light incident upon the waveguide plate is emitted in a first direction and a second light exit surface through which the light incident upon the waveguide plate is emitted in a second direction, the second direction being opposite to the first direction, and a two-directions light transmission transflective prism sheet arranged at one side of the waveguide plate and comprising a two-directions light transmission transflective film that reflects some incident light irradiated from a light source and transmits the remainder of the light, and a plurality of prism patterns formed on one surface of the two-directions light transmission transflective film, the plurality of prism patterns having a predetermined height and a predetermined width;
a first LCD panel disposed at one side of the two-directions backlight assembly toward the first direction and displaying a first image; and
a second LCD panel disposed at the other side of the two-directions backlight assembly toward the second direction and displaying a second image.

27. The two-directions LCD of claim 26, further comprising:
a plurality of first optical sheets arranged on the first light exit surface for enhancing the brightness of light emitted through the first light exit surface in the first direction; and
a plurality of second optical sheets arranged on the second light exit surface for enhancing the brightness of light emitted through the second light exit surface in the second direction.
